(19) United States
(12) Patent Application Publication
(10) Pub. No.: US 2010/0110866 A1
(43) Pub. Date: May 6, 2010

(54) OPTICAL DISC REPRODUCING LIGHT QUANTITY SETTING METHOD AND OPTICAL DISC APPARATUS

(76) Inventors: Nobuo Takeshita, Tokyo (JP); Toshiya Matozaki, Tokyo (JP)

Correspondence Address: BIRCH STEWART KOLASCH & BIRCH, PO BOX 747, FALLS CHURCH, VA, 22040-0747, US

(21) Appl. No.: 12/596,075

(22) PCT Filed: Mar. 31, 2008
(86) PCT No.: PCT/JP2008/056312

§ 371 Date: Oct. 15, 2009

(30) Foreign Application Priority Data
May 16, 2007 (JP) 2007-130032
Sep. 14, 2007 (JP) 2007-238807

(51) Int. Cl. G11B 7/135

(52) U.S. Cl. 369/116; G9B/7.112

(57) ABSTRACT

In a method of setting a quantity of light directed onto an optical disc for reproduction purposes, an area of the optical disc in which information has been recorded is reproduced with a test-reproducing light quantity (S14, S24), a reproduction time or number of reproductions up to the time when the reproduced signal quality value reaches a prescribed value is determined (S20, S30), and the quantity of reproducing light used in regular reproduction is set by performing calculations with the determined value (S32). The state in which recorded marks have significantly degraded can also be detected, and degradation of the recorded marks to the unreproducible state can be avoided.

### FIELD OF THE INVENTION

The present invention relates to a method of setting the reproducing light quantity for playing an optical disc, and to an optical disc apparatus using that method; the invention holds the amount of degradation of information on the optical disc due to the reproducing light to within a predetermined range.

### BACKGROUND ART

When an optical disc is played, there are mutually contradictory demands on the reproducing light quantity, as follows. From the perspective of reproduced signal quality, reproduction with the greatest quantity of light is advantageous because it can reduce noise. From the viewpoints of the ability of the optical disc to withstand quantities of reproducing light and the operating life of the semiconductor laser, reproduction with the smallest quantity of light is advantageous. Given these conflicting demands, the desired setting of the reproducing light quantity maintains a minimum reproduced signal quality without causing any degradation of the characteristics of the recorded marks on the optical disc, so that the optical disc can be used as long as possible.

In conventional optical disc apparatus, in still reproduction, in which the same track is reproduced repetitively, the track is affected by considerable thermal damage, which degrades the recorded marks that embody the information recorded on that part, and thus degrades the quality of the reproduced signal. To counter this problem, the reproducing light quantity has been controlled by detecting the reproduced signal amplitude and compensating for changes in the reproduced signal amplitude (see, for example, Patent Document 1).

Patent Document 1: Japanese Patent Application Publication No. 2001-34944 (pp. 1-6, FIG. 9)

### DISCLOSURE OF THE INVENTION

### Problems to be Solved by the Invention

With the conventional optical disc apparatus described above, because only changes in the reproduced signal amplitude are detected, even significantly degraded states of the recorded marks cannot be detected, so the recorded marks may degrade to an unreproducible state. As described in Patent Document 1 above, changes in the reproduced signal amplitude are detected by using user areas on the optical disc reproduced to display still images, so recorded marks that are necessary to the user may be degraded to an unreproducible state.

### Means of Solution of the Problems

This invention provides an optical disc reproducing light quantity setting method for setting a quantity of light directed onto an optical disc for reproduction purposes, wherein:

an area of the optical disc in which information is recorded is test-reproduced by using a test-reproducing light quantity;

a reproduction time or a number of reproductions until a quality value of the test-reproduced signal reaches a prescribed value is determined; and

those values are used to determine a maximum reproducing light quantity assuring a prescribed reproduction time or number of reproductions and the determined maximum reproducing light quantity is set as a reproducing light quantity for regular reproduction.

### Effect of the Invention

With the present invention it is possible to prevent degradation, to an unreproducible state, of the recording marks that embody recorded information on the optical disc.

### BRIEF DESCRIPTION OF THE DRAWINGS

FIG. 1 is a schematic drawing illustrating the main parts of an optical disc apparatus in a first embodiment of the invention.

FIG. 2 is a flowchart illustrating an exemplary operation sequence performed by using the optical disc in FIG. 1 to set the reproducing light quantity.

FIG. 3 is a quality characteristic diagram based on measurements showing a relationship between reproduction time and jitter value during reproduction carried out in FIG. 1 for an extended time with an appropriate reproducing light quantity.

FIG. 4 is a quality characteristic diagram based on measurements showing a relationship between reproduction time and jitter value during reproduction carried out in FIG. 1 for an extended time with a reproducing light quantity considerably greater than the appropriate quantity.

FIG. 5 is a quality characteristic diagram based on measurements showing relationships between reproduction time and jitter value during reproduction carried out in FIG. 1 with the reproducing light quantity as a parameter.

FIG. 6 is an Arrhenius-plot diagram showing the relationship between the reciprocal of the reproducing light quantity in FIG. 5 and the natural logarithm of the reproduction time taken for the jitter value to reach the limit tolerance.

FIG. 7 is a drawing illustrating a method of determining the reproducing light quantity Lg for use in reproduction from the result of test-reproduction.

FIG. 8 is a flowchart illustrating another exemplary operation sequence performed by using the optical disc apparatus in FIG. 1 to set the reproducing light quantity.

FIG. 9 is a schematic diagram illustrating a test recording area on an optical disc used in a second embodiment.

FIG. 10 is a current-emission relationship diagram illustrating the relationship between the driving waveform applied to the light source 2 used in a third embodiment and the beam 3 emitted from the light source 2.

FIG. 11 is a schematic diagram illustrating the emission from the light source 2 in FIG. 10.

FIGS. 12a and 12b are current-emission relationship diagrams similar to the diagram in FIG. 10, illustrating changes in emission quantity versus changes of the center value C of the driving current.

FIGS. 13a and 13b are current-emission relationship diagrams similar to the diagram in FIG. 10, illustrating changes in the emission quantity versus changes in the amplitude M of the driving current.

### EXPLANATION OF REFERENCE CHARACTERS

1 optical disc, 2 light source, 3 beam, 4 collimator lens, 5 prism, 6 objective lens, 7 focused spot, 8 focusing lens, 9 photodetector, 10 amplifier circuit, 11 signal processing unit, 12 control calculation unit, 13 light source control unit, 20 recordable optical disc, 21 user data area, 22 management area, 23 disc test area.

### BEST MODE FOR CARRYING OUT THE INVENTION

### First Embodiment

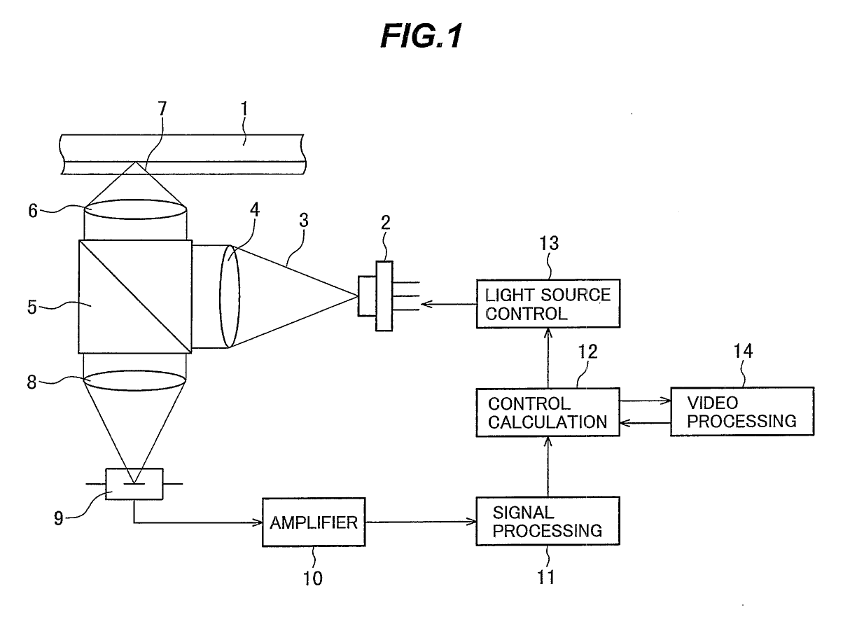

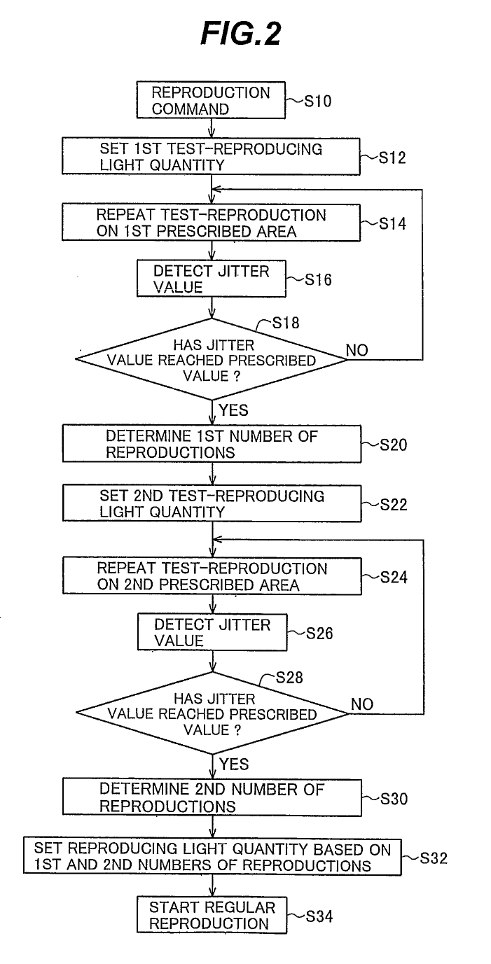

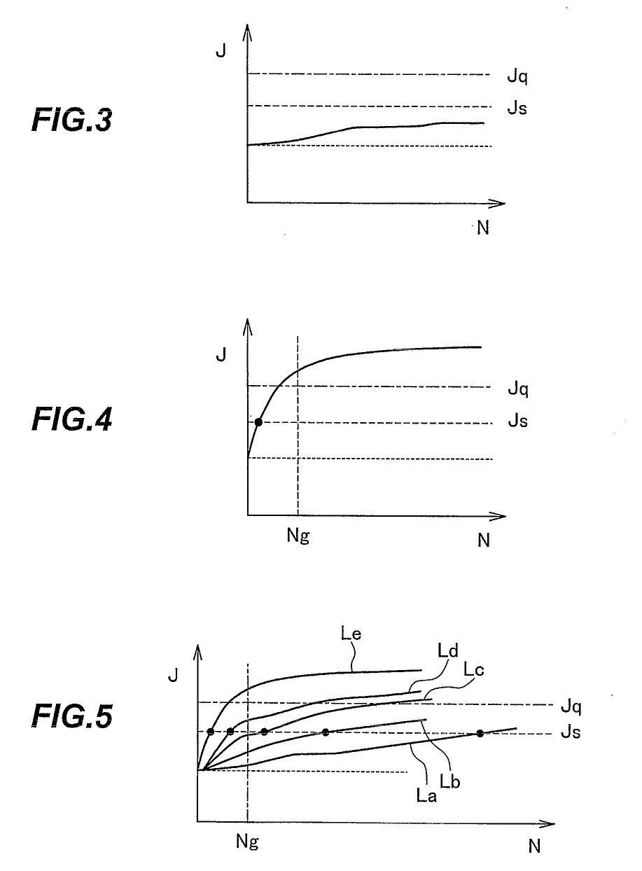

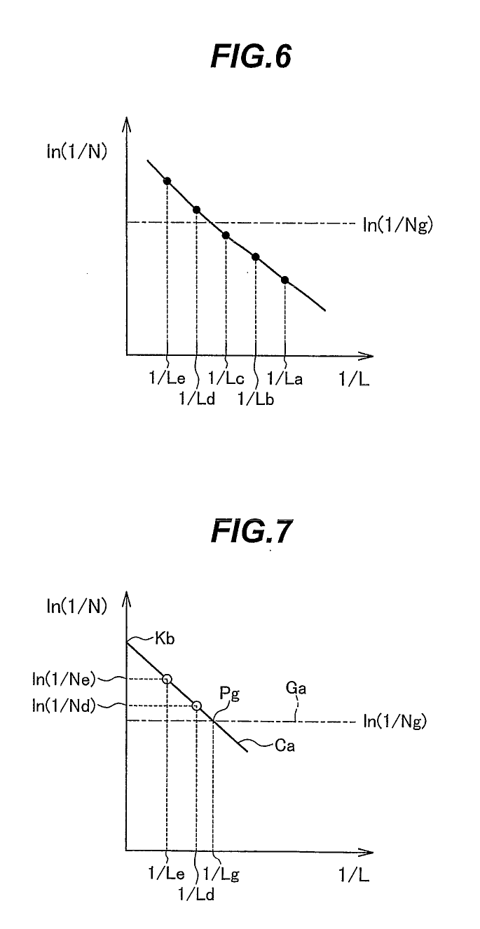

FIG. 1 is a schematic diagram illustrating the main parts of an optical disc apparatus in a first embodiment of the invention; FIG. 2 is a flowchart illustrating an operation sequence performed by using the apparatus in FIG. 1 to set the reproducing light quantity; FIG. 3 is a diagram showing variations in jitter value versus reproduction time during reproduction carried out for an extended time with an appropriate reproducing light quantity; FIG. 4 is a diagram showing variations in jitter value versus reproduction time during reproduction carried out for an extended time with a reproducing light quantity considerably greater than the appropriate quantity; FIG. 5 is a diagram showing variations in jitter value versus reproduction time with reproducing light quantity as a parameter, including FIGS. 3 and 4; FIG. 6 is an Arrhenius-plot diagram showing the relationship of the reciprocal (1/L) of the reproducing light quantity in FIG. 5 and the natural logarithm of the reciprocal (1/N) of the reproduction time (number of reproductions) taken for the jitter value to reach a tolerance setting Js.

The first embodiment of the invention will now be described with reference to the drawings. In FIG. 1, the optical disc 1 is driven by a motor (not shown) and is rotating. A beam 3 emitted from a light source 2 is collimated by a collimator lens 4, reflected by a prism 5, and focused onto the optical disc 1 by an objective lens 6 as a focused spot 7. The beam that has been reflected by the optical disc 1 retraces the above light path, passing through the objective lens 6, the prism 5, and a focusing lens 8, and is received by a photodetector 9. The beam received by the photodetector.9 is photoelectrically converted in the photodetector 9 and passes through an amplifier circuit 10 to a signal processing unit 11, in which a jitter value is detected as an index of reproduced signal quality.

The detected jitter value is sent to a control calculation unit 12, and then to a video processing unit 14, wherein audio, video, and other processing is performed.

The control calculation unit 12, which comprises, for example, a programmed computer, performs control and calculation processing for the entire optical disc apparatus.

The optical disc reproducing light quantity setting method in this embodiment sets the quantity of light directed onto the optical disc to reproduce it; an area on the optical disc in which information has been recorded is repeatedly test-reproduced by using a test-reproducing light quantity; the repeated reproduction time or the number (N) of repeated reproductions of the area required for the quality value of the test-reproduced signal to reach a prescribed value is determined; these values are used to determine a maximum reproducing light quantity that guarantees the prescribed reproduction time or number of reproductions; the determined maximum reproducing light quantity is set as the reproducing light quantity for regular reproduction. The reproduction time is proportional to the number of reproductions, so in the following description, the terms ‘reproduction time’ and ‘number of reproductions’ may be used with the same meaning.

The processing for setting the reproducing light quantity will be described with reference to FIG. 2.

When a reproduction command for the optical disc is received from a video processing unit 14 (S10), the control calculation unit 12 issues a command to emit light with a first prescribed light quantity to a light source control unit 13 (S12). That is, a first test-reproducing light quantity is set and a command to emit light with that light quantity is issued.

The control calculation unit 12 also controls the photodetector 9, the signal processing unit 11, and so on so as to repeatedly reproduce a first prescribed area (test area) as described above with that light quantity (the first prescribed light quantity) and detect the jitter value (S14, S16, S18). That is, the control calculation unit 12 reproduces the first prescribed area a prescribed number of times (for example, M times) (S14), detects the jitter value (S16), and determines whether the detected jitter value has reached a prescribed value (has degraded'to a prescribed minimum reproduced signal quality level) (S18); if the prescribed value has not been reached, the control calculation unit 12 repeats the above reproducing step and subsequent steps (S14, S16, S18).

When the prescribed value, is reached in step S18, the control calculation unit 12 determines and stores the number of reproductions up to that time (the number of reproductions from the first reproduction in step S14, also referred to below as the ‘first number of reproductions’; if the same area is reproduced M times as described above every time step S14 is performed, the first number of reproductions equals a value obtained by multiplying the number of repetitions of steps S14, S16, and S18 by M) (S20).

The value of M need not be constant, but may be varied every time step S14 is repeated. For example, the value of M may be decreased as the jitter value increases and approaches the prescribed value.

Then, the control calculation unit 12 issues a command to the light source control unit 13 to change the reproducing light quantity (S22), and operates in the same way as above (S24, S26, S28). That is, the control calculation unit 12 issues a command to emit light with a second prescribed light quantity (differing from the above first prescribed light quantity) (S22). That is, a second test-reproducing light quantity is set and a command to emit light with that light quantity is issued.

The control calculation unit 12 also controls the photodetector 9, the signal processing unit 11, and so on so as to repeatedly reproduce a second prescribed area (test area) as described above with that light quantity (the second prescribed light quantity) and detect the jitter value (S24, S26, S28). That is, the control calculation unit 12 reproduces the second prescribed area a prescribed number of times (for example, M times) (S24), detects the jitter value (S26), and determines whether the detected jitter value has reached a prescribed value (has degraded to a prescribed minimum reproduced signal quality level) (S28); if the prescribed value has not been reached, the control calculation unit 12 repeats the above reproducing step and subsequent steps (S24, S26, S28).

When the prescribed value is reached in step S28, the control calculation unit 12 determines and stores the number of reproductions up to that time (the number of reproductions from the first reproduction in step S24, also referred to below as the ‘second number of reproductions’; if the same area is reproduced M times as described above every time step S24 is performed, the second number of reproductions equals a value obtained by multiplying the number of repetitions of steps S24, S26, and S28 by M) (S30).

The value of M need not be constant, but may be varied every time step S14 is repeated. For example, the value of M may be decreased as the jitter value increases and approaches the prescribed value.

The control calculation unit 12 then uses the first and second number of reproductions that it has obtained through the above operations and the corresponding first and second test-reproduction light quantities to determine a reproducing light quantity for use in reproduction (also referred to below as ‘regular reproduction’ to distinguish it from the test-reproduction performed in steps S14 and S24) for the intended use of the data (for example, watching or listening to the reproduced data) (S32). The method of determining the reproducing light quantity will be described later.

Then regular reproduction is performed with the determined reproducing light quantity (S34).

The relationship between reproduction time and the jitter value detected as an index of reproduced signal quality will be described with reference to FIGS. 3 and 4. FIG. 3 shows an example in which an appropriate reproducing light quantity is set (a case in which the reproducing light quantity is set to a sufficiently low value from a view point of of disc endurance versus the reproducing light quantity). In the example in FIG. 3, even if continuous reproduction is performed for the number of times an ordinary optical disc apparatus needs to be capable of reproduction, the change in jitter value is small, so reproduction can continue without exceeding the limit tolerance value Jq at which the quality of the recorded marks approaches the unreproducible state. The jitter value does not even reach the tolerance setting Js, which is set sufficiently below the limit tolerance value Jq, to allow a margin with respect to the limit tolerance value Jq.

FIG. 4 shows an example in which a reproducing light quantity considerably greater than the appropriate reproducing light quantity is set. In this example, even when the number of reproductions is less than the guaranteed number of reproductions Ng, during continuous reproduction the jitter value changes greatly, quickly exceeding both the tolerance setting Js and the limit tolerance value Jq, which may degrade the reproduced signal quality and generate block noise in the reproduced video, or in some cases cause reproduction to stop.

The relationship between the reproducing light quantity and reproduced signal quality will be described with reference to FIG. 5. In FIG. 5, when the reproducing light quantity changes from the La state to the Le state, a change occurs toward a state in which the endurance time up to the time when the jitter value exceeds the tolerance setting Js is shortened (the number of reproductions up to the time when the jitter value reaches the prescribed value decreases). The degree of change is such that the endurance time does not change too much for La and Lb, which are in the region of comparatively small quantities of reproducing light; the endurance time changes substantially for Ld and Le, which are in the region of comparatively large quantities of reproducing light. That is, when a certain reproducing light quantity is approached, the worsening of the jitter value (degradation of the reproduced signal quality) proceeds very rapidly.

Referring to FIG. 6, the material of the optical disc in which the recorded marks are formed will be described by use of an Arrhenius-plot diagram. The Arrhenius equation for predicting the chemical reaction rate of a material at a certain temperature is generally expressed as equation (1), using a rate constant k, a temperature-independent constant (frequency factor) A, an activation energy E, the gas constant R, and temperature T.

k=A*exp(−E/RT) (1)

Taking natural logarithms on both sides gives the expression in equation (2).

ln(k)=(−E/R)*(1/T)+ln(A) (2)

In the Arrhenius-plot diagram in FIG. 6, the horizontal axis indicates the reciprocal (1/L) of the reproducing light quantity L, and because the temperature at the focused spot 7 on the optical disc 1 is generally proportional to the reproducing light quantity L, the horizontal axis corresponds to the reciprocal (1/T) of the temperature T.

The vertical axis indicates the natural logarithm ln(1/N) of the reciprocal (1/N) of the reproduction time (number of reproductions) N taken for the jitter value to reach the tolerance setting, such as the reproduction time N taken for the jitter value to reach the tolerance setting Js, with each of the reproducing light quantities in FIG. 5; this is equivalent to the natural logarithm ln(k) of the rate constant k in the Arrhenius plot.

The intercept on the vertical axis in FIG. 6 can be represented as corresponding to ln(A) by taking an appropriate value as the frequency factor in equation (2). The slope of the curve in FIG. 6 is thereby determined as a value corresponding to (−E/R).

By replacing k in equation (2) with (1/N), (1/T) with (1/L), (−E/R) with a constant Ka, and ln(A) with a constant Kb, the following equation (3) is obtained.

ln(1/N)=Ka*(1/L)+Kb (3)

In FIG. 6, by determining the number of reproductions taken for the jitter value to reach the tolerance setting when the reproducing light quantity L has relatively large values, such as Ld and Le, and extrapolating on the basis of these results, whether the number of reproductions taken for the jitter value to reach the tolerance setting Js with a given reproducing light quantity is acceptable or not can be calculated, and the reproducing light quantity can be set on the basis of the result.

In step S12 in FIG. 2 above, the reproducing light quantity is set, for example, to Le, and in step S22, the reproducing light quantity is set, for example, to Ld. Then the numbers of reproductions Ne, Nd, respectively taken for the jitter value J to reach the tolerance setting Js are determined in steps S20 and S30, respectively; these results are plotted on the graph in FIG. 7, which is similar to FIG. 6, the point Pg at which the line Ca connecting those two points intersects the line Ga representing the reciprocal (1/Ng) of the guaranteed number Ng of reproductions is determined, the reciprocal (1/Lg) of the reproducing light quantity at point Pg is determined, and the reproducing light quantity Lg corresponding to that value is set as the reproducing light quantity for use in regular reproduction.

The above process has been described as being carried out on a graph, but it may be carried out by corresponding computational operations. For example, using the data Ne, Nd determined at the above two points, the following equation (4) obtained by substituting Ne and the corresponding Le for N and L in equation (3) and the following equation (5) obtained by substituting Nd and the corresponding Ld for N and L in equation (3) may be solved as simultaneous equations to obtain the constants Ka and Kb (by equations (6) and (7)), and the predetermined Ng may be substituted into equation (3), in which constants Ka and Kb have become known as shown by equations (6) and (7), to obtain the corresponding Lg.

ln(1/Ne)=Ka*(1/Le)+Kb (4)

ln(1/Nd)=Ka*(1/Ld)+Kb (5)

Ka={ln(1/Ne)−ln(1/Nd)}/{1/Le}−(1/Ld)} (6)

Kb={ln(1/Ne)·(1/Ld)−ln(1/Nd)·(1/Le)}/{(1/Ld)/{(1/Le)} (7)

When the processing shown in FIG. 2 is carried out, if the characteristics of the optical disc degrade over a small ‘number of reproductions (a number of reproductions less than the guaranteed number of reproductions Ng) despite the use of the reproducing light quantity (for example, a quantity around Lc) that assures the minimum reproduced signal quality, it may be so arranged that the user is notified and given a chance to decide whether to continue or stop reproduction, if the next operation is reproduction, or whether to continue or stop recording, if the next operation is recording, and it may further be so arranged that the reproducing or recording be stopped if it is determined that characteristics are bound to degrade.

In FIG. 2, test-reproduction is repeated (S14 and S24) until the jitter value reaches the prescribed value, but if the jitter value does not reach the prescribed value (the reproduced signal quality value does not reach the prescribed value) when the number of reproductions has reached a prescribed value Nh, the reproducing light quantity may be set to a prescribed value and regular reproduction may begin.

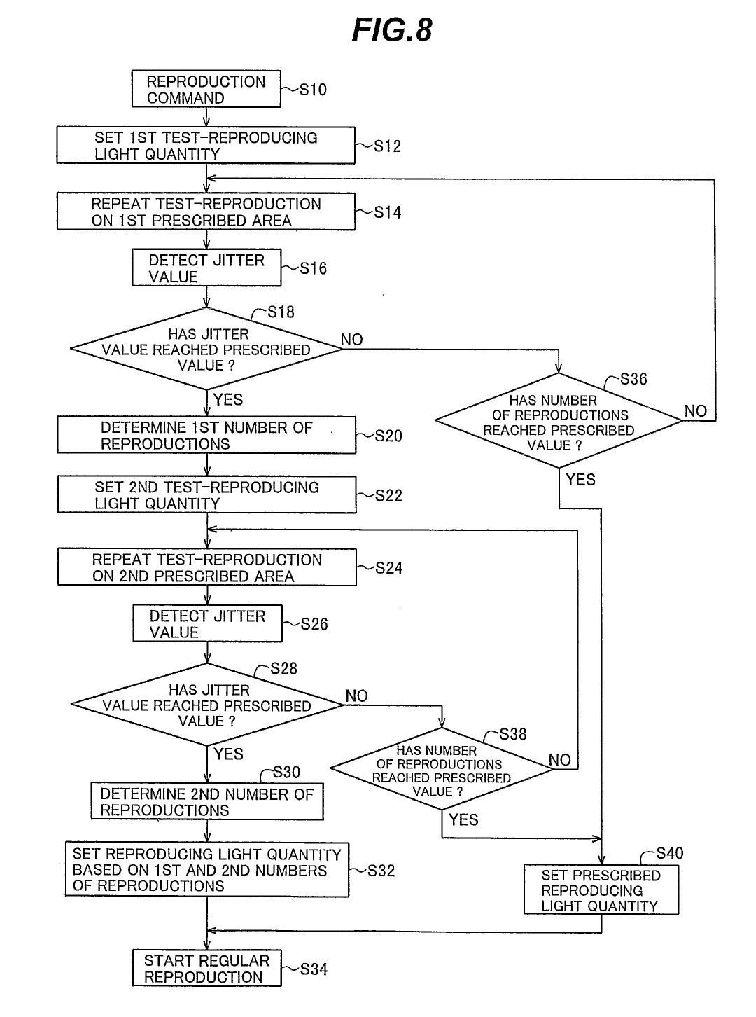

As shown in FIG. 8 (which is generally the same as FIG. 2, except that steps S36, 538, and S40 are added), for example, if the result is ‘No’ in step S18, then whether or not the number of reproductions has reached the prescribed value Nh is decided (S36); if this value has not been reached, the processing returns to step S14, and if this value has been reached, a prescribed reproducing light quantity is set (S40), and regular reproduction is started (S34).

Similarly, if the result is ‘No’ in step S28, whether or not the number of reproductions has reached the prescribed value Nh is decided (S38); if this value has not been reached, the processing returns to step S24; if this value has been reached, a prescribed reproducing light quantity is set (S40), and regular reproduction is started (S34). This is because it has been determined that the optical disc has adequate endurance for the reproducing light quantity and accordingly the jitter value will not reach the prescribed value (the reproduction quality will not reach the prescribed value) even if the number of reproductions reaches the prescribed value Nh.

When the reproduction time or number of reproductions taken for the reproduced signal quality value to reach the prescribed value is actually determined, the degradation characteristic of the recorded marks depends significantly on the material in which the recorded marks are formed, and accordingly, the prescribed reproducing light quantity may be set when the optical disc apparatus is manufactured, from overall considerations of the need to reduce the time required for starting reproduction and the need to improve the setting precision of the reproducing light quantity as much as possible.

In order to reduce the time taken for deciding the reproducing light quantity, the rotational rate (rotational velocity) of the optical disc may be increased (raised) above the rotational rate in regular reproducing. In that case, it is possible to maintain the setting precision of the reproducing light quantity while reducing the evaluation time by setting the test-reproducing light quantity to a value multiplied by an appropriate factor (and increasing the reproducing light quantity, if the rotational rate is increased).

The reproducing light quantity may be set by holding the gas constant R fixed and selecting an appropriate representative value for the activation energy E, thereby making the slope of line Ka in FIG. 7 constant, setting a single test-reproducing light quantity, determining the number of reproductions, and performing computational operations by using the determined value.

In order to avoid the lengthening of the time until reproduction starts, caused by the operations shown in FIG. 2, it is also possible to give the user a chance to select whether or not to carry out this process.

In the above method, the jitter value is used as an index of reproduced signal quality, but an error rate may be used instead.

In the above example, the area to be reproduced with the test-reproducing light quantity was not specified, but it may be specified randomly for each reproduction in order to prevent a particular area from deteriorating rapidly through being overly reproduced.

The first embodiment of the invention produces the effect that the recorded marks that embody recorded information on an optical disc are not degraded to the extent that they cannot be reproduced. In addition, if characteristic degradation of an optical disc occurs even with the reproducing light quantity that guarantees the minimum reproduced signal quality, it is possible to notify the user and give the user a chance to make a decision, such as whether to continue or halt reproduction, thereby enabling an optimal selection to be made according to the intended purpose or application.

### Second Embodiment

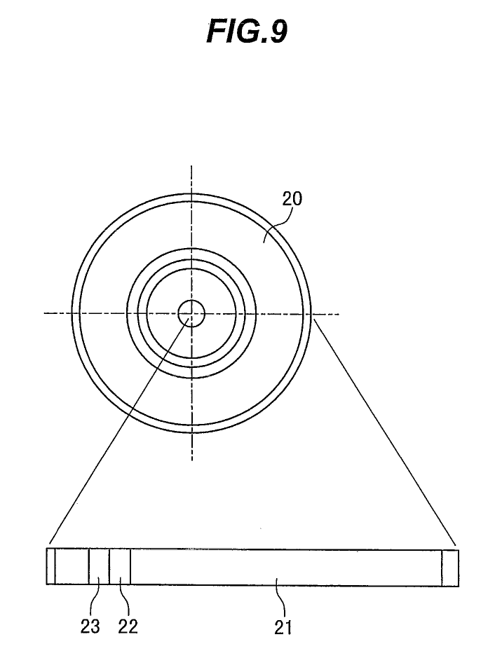

A second embodiment will now be described. The schematic drawing showing the structure of the optical disc apparatus in the second embodiment is the same as FIG. 1. FIG. 9 is a schematic diagram showing a test recording area on the optical disc used in the second embodiment.

In FIG. 9, a recordable optical disc 20 has a management area 22 disposed on the inner circumference side of the user data area 21, and a disc test area 23 disposed on the inner circumference side of the management area 22. The disc test area 23 is normally used in test recording, to set the optimal recording light quantity; a recording light quantity suitable for the optical disc is set by a known test method. In this embodiment, after the optimal recording light quantity is determined, a prescribed amount of test information is recorded in the disc test area 23 with the optimal recording light quantity. The amount may be the minimum necessary amount. Operations similar to the operations in the first embodiment are then performed, using the test information, to set the reproducing light quantity far use in regular reproduction.

In the second embodiment as well, it may be so arranged that when the processing in FIG. 2 is carried out, if the characteristics of the optical disc degrade over a small number of reproductions (a number of reproductions less than the guaranteed number of reproductions Ng) despite the use of the reproducing light quantity that assures the minimum reproduced signal quality, the user is notified and given a chance to decide whether to continue or stop reproduction, if the next operation is reproduction, and it may further be so arranged that the reproducing or recording may be stopped if it is determined that the characteristics are bound to degrade.

As described in relation to the first embodiment with reference to FIG. 8, it may be so arranged that a preset reproducing light quantity is used when the reproduced signal quality value does not reach a prescribed value within a prescribed reproduction time or number of reproductions. This is because such an optical disc has adequate endurance with respect to the reproducing light quantity.

When the reproduction time or number of reproductions taken for the reproduced signal quality value to reach the prescribed value is actually determined, the degradation characteristic of the recorded marks depends significantly on the material in which the recorded marks are formed, and accordingly, the preset reproducing light quantity may be set when the optical disc apparatus is manufactured, from overall considerations of the need to reduce the time required for starting reproduction and the need to improve the setting precision of the reproducing light quantity as much as possible.

In order to reduce the time for deciding the reproducing light quantity, the rotational rate (rotational velocity) of the optical disc may be increased (raised) above the rotational rate in regular reproducing. In that case, it is possible to maintain the setting precision of the reproducing light quantity while reducing the evaluation time by setting the test-reproducing light quantity to a value multiplied by an appropriate factor (and increasing the reproducing light quantity, if the rotational rate is increased).

In order to avoid the lengthening of the time until reproduction starts, caused by the operations shown in FIG. 2, it is also possible to give the user a chance to select whether or not to perform this process.

In the above method, the jitter value is used as an index of reproduced signal quality, but an error rate may be used instead.

The second embodiment enables the test of reproduced signal quality to be performed by using a test area located outside the user data area, with the effect that the risk of degrading important content in the user data area can be further reduced. Another effect is that the recorded marks that embody recorded information on the optical disc are not degraded to the extent that they cannot be reproduced. In addition, if characteristic degradation of an optical disc occurs even with the reproducing light quantity that guarantees the minimum reproduced signal quality, it is possible to notify the user and give the user a chance to make a decision, such as whether to continue or halt reproduction, thereby enabling an optimal selection to be made according to the intended purpose or application.

### Third Embodiment

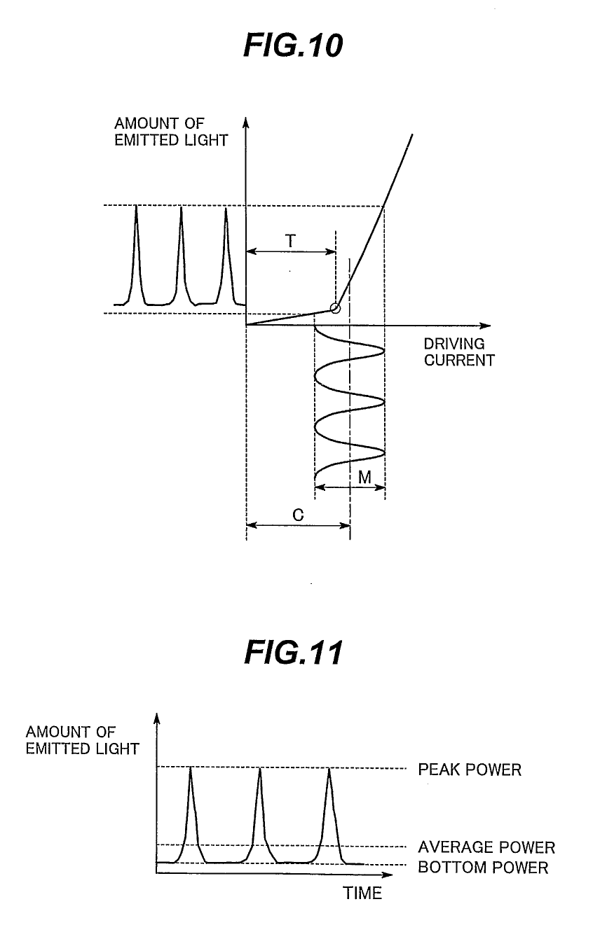

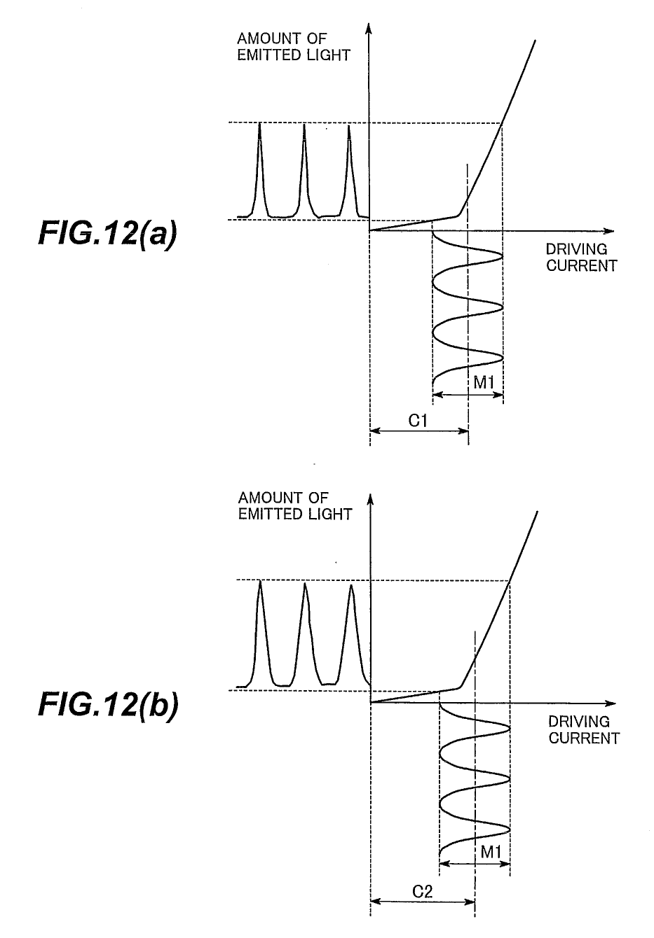

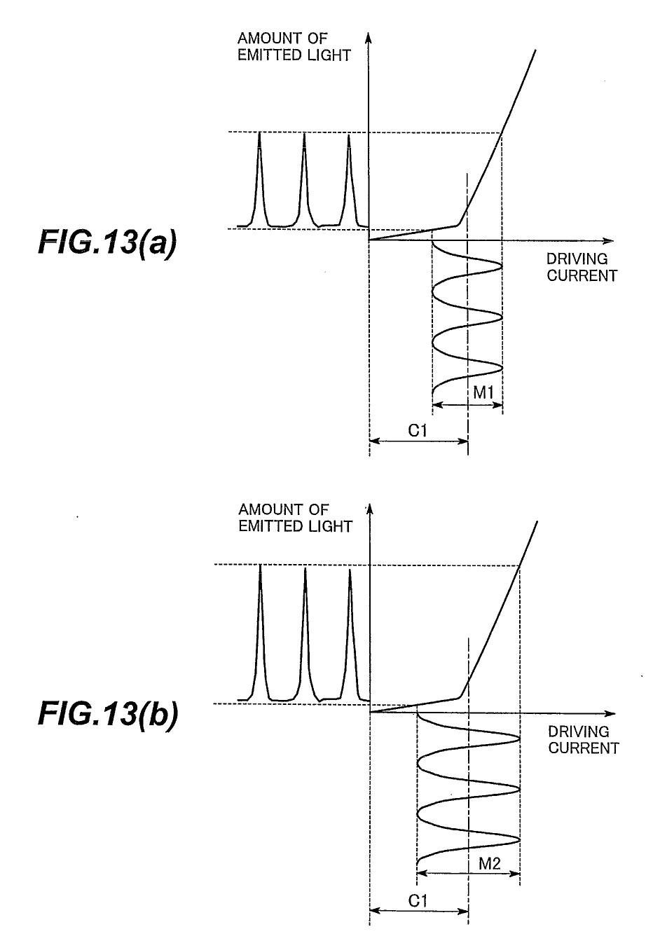

The third embodiment of the invention will now be described. The schematic drawing showing the structure of the optical disc apparatus in the third embodiment is the same as FIG. 1. FIG. 10 is a current-emission relationship diagram showing the relationship between a high-frequency driving current waveform applied to the light source 2 used in the third embodiment and amount of emitted light when the beam 3 emitted from the light source 2 includes a high-frequency component (i.e., consists of a high-frequency component superimposed on a direct current component). In FIG. 10, the center value C of the driving current indicates the direct current component. FIG. 11 is a schematic drawing showing temporal variations in quantity of light emitted by the light source 2, indicating the peak power, bottom power, and average power. FIGS. 12(a) and 12(b) are current-emission relationship diagrams similar to FIG. 10, and show variations in emission quantity when the center value C of the driving current is changed to different values C1, C2 (C2>C1). FIGS. 13(a) and 13(b) are current-emission relationship diagrams similar to FIG. 12(a), showing variations in light emission quantity due to variations in the amplitude value M of the driving current. FIG. 13(a) shows the case in which the amplitude value M is M1, the same as in FIG. 12(a); FIG. 13(b) shows a case in which the amplitude value M is M2, which is greater than M1.

In FIG. 10, the light source 2 emits a laser beam when the driving current applied to the light source 2 exceeds the threshold value T, so the beam 3 emits intermittent high-frequency pulses as shown in FIGS. 10 and 11. Incidentally, the purpose of applying high frequency input in this way to lasers in the known art is to improve the CN ratio of the reproduced signal by producing multi-mode lasing and thus a relative reduction in noise.

In the third embodiment, when the light emission quantity is adjusted, the light source control unit 13 can freely set the central value C or the amplitude M of the applied high frequency amount shown in FIG. 10. As shown in FIGS. 12(a) and 12(b), when the central value C is varied between C1 and C2, the duty cycle (the ratio of the time when the current exceeds the threshold value T) varies, so the duty cycle of the emission waveform also varies, principally causing the average power of the light emission to change.

As shown in FIGS. 13(a) and 13(b), when the amplitude value M is varied between M1 and M2, the duty cycle (the ratio of the time when the current exceeds the threshold value T) does not change very much, and therefore the duty cycle of the emission waveform hardly changes at all; principally it is the amount superimposed (the strength of the emitted light) that changes.

An optical disc's sensitivity to reproducing light and the amount of degradation caused by reproducing light depend greatly on the recording film material used by the manufacturer: some optical discs react sensitively to variation in the central value C; some optical discs react sensitively to variation in the amplitude value M.

A management area indicating information about the manufacturer and recording film material is provided on the inner circumference side of the optical disc, so when the management area is reproduced, the manufacturer and recording film material can be identified.

Accordingly, if the central value C or amplitude value M is adjusted selectively, the reproducing light quantity can be adjusted efficiently responsive to the degradation due to reproducing light.

1. An optical disc reproducing light quantity setting method for setting a quantity of light directed onto an optical disc for reproduction purposes, wherein:
an area of the optical disc in which information is recorded is test-reproduced by using a test-reproducing light quantity;
a reproduction time or a number of reproductions until a quality value of a test-reproduced signal reaches a prescribed value is determined; and
those values are used to determine a maximum reproducing light quantity assuring a prescribed reproduction time or number of reproductions and the determined maximum reproducing light quantity is set as a reproducing light quantity for regular reproduction.

2. The optical disc reproducing light quantity setting method of claim 1, wherein the test-reproducing light quantity is set to a value larger than the reproducing light quantity used in regular reproduction.

3. The optical disc reproducing light quantity setting method of claim 1, wherein a jitter value is used as the quality value of the test-reproducing light quantity.

4. The optical disc reproducing light quantity setting method of claim 1, wherein reproduction is made by using a plurality of test-reproducing light quantities and the reproducing light quantity is set by using an expression relating a reciprocal of the test-reproducing light quantity and a natural logarithm of a reciprocal of the reproduction time or the number of reproductions until the quality value of the reproduced signal reaches the prescribed value.

5. The optical disc reproducing light quantity setting method of claim 1, wherein the maximum reproducing light quantity is determined by using an Arrhenius plot indicating a reciprocal of the test-reproducing light quantity on a horizontal axis and a natural logarithm of a reciprocal of the reproduction time or the number of reproductions until the quality value of the test-reproduced signal reaches the prescribed value on a vertical axis.

6. The optical disc reproducing light quantity setting method of claim 1, wherein reproduction is carried out by using one test-reproducing light quantity and the reproducing light quantity is set by using an expression relating a reciprocal of the test-reproducing light quantity and a natural logarithm of a reciprocal of the reproduction time or the number of reproductions until the quality value of the reproduced signal reaches the prescribed value.

7. The optical disc reproducing light quantity setting method of claim 6, wherein the maximum reproducing light quantity is determined by using an Arrhenius plot indicating the reciprocal of the test-reproducing light quantity on a horizontal axis and the natural logarithm of the reciprocal of the reproduction time or the number of reproductions until the quality value of the test-reproduced signal reaches the prescribed value on a vertical axis, the Arrhenius plot having a fixed slope.

8. The optical disc reproducing light quantity setting method of claim 1, wherein the test-reproduced area is an area other than an area used by a user.

9. The optical disc reproducing light quantity setting method of claim 1, wherein the test-reproduced area is an area for determining a recording light quantity for a recordable optical disc.

10. The optical disc reproducing light quantity setting method of claim 1, wherein if the quality value of the reproduced signal does not reach the prescribed value within a prescribed reproduction time or within a prescribed number of reproductions, a predetermined reproducing light quantity is set.

11. The optical disc reproducing light quantity setting method of claim 1, wherein the test-reproducing light has a direct current component on which a high frequency component is superimposed, and the reproducing light quantity is set by varying a central value or an amplitude value of the high frequency component.

12. The optical disc reproducing light quantity setting method of claim 1, wherein the test-reproducing light has a direct current component on which a high frequency component is superimposed, and the reproducing light quantity is set by selectively varying a central value or an amplitude value of the high frequency component based on manufacturer information of the optical disc.

13. An optical disc apparatus for setting a quantity of light directed onto an optical disc for reproduction purposes, comprising:
a reproducing unit configured to test-reproduce an area of the optical disc in which information is recorded by using a test-reproducing light quantity; and
a quality degradation detection unit configured to determine a reproduction time or a number of reproductions until a quality value of a test-reproduced signal reaches a prescribed value; wherein
those values are used to determine a maximum reproducing light quantity assuring a prescribed reproduction time or number of reproductions and the determined maximum light quantity is set as a reproducing light quantity for regular reproduction.

14. The optical disc apparatus of claim 13, wherein the reproducing unit uses, as the test-reproducing light quantity, a value greater than the reproducing light quantity used in regular reproduction.

15. The optical disc apparatus of claim 13, wherein the quality degradation detection unit uses a jitter value as the quality value of the test-reproduced signal.

16. The optical disc apparatus of claim 13, wherein:
the reproducing unit uses a plurality of test-reproducing light quantities; and
the light quantity setting unit sets the reproducing light quantity by using an expression relating a reciprocal of the test-reproducing light quantity and a natural logarithm of a reciprocal of the reproduction time or the number of reproductions until the quality value of the reproduced signal reaches the prescribed value.

17. The optical disc apparatus of claim 13, wherein the light quantity setting unit determines the maximum reproducing light quantity by using an Arrhenius plot indicating a reciprocal of the test-reproducing light quantity on a horizontal axis and a natural logarithm of a reciprocal of the reproduction time or the number of reproductions until the quality value of the test-reproduced signal reaches the prescribed value on a vertical axis.

18. The optical disc apparatus of claim 13, wherein:
the reproducing unit carries out reproduction by using one test-reproducing light quantity; and
the light quantity setting unit sets the reproducing light quantity by using an expression relating a reciprocal of the test-reproducing light quantity and a natural logarithm of a reciprocal of the reproduction time or the number of reproductions until the quality value of the reproduced signal reaches the prescribed value.

19. The optical disc apparatus of claim 18, wherein the light quantity setting unit determines the maximum reproducing light quantity by using an Arrhenius plot indicating the reciprocal of the test-reproducing light quantity on a horizontal axis and the natural logarithm of the reciprocal of the reproduction time or the number of reproductions until the quality value of the test-reproduced signal reaches the prescribed value on a vertical axis, the Arrhenius plot having a fixed slope.

20. The optical disc apparatus of claim 13, wherein the reproducing unit test-reproduces an area other than an area used by a user.

21. The optical disc apparatus of claim 13, wherein the reproducing unit test-reproduces an area for determining a recording light quantity for a recordable optical disc.

22. The optical disc apparatus of claim 13, wherein: if the degradation detection unit determines that the quality value of the reproduced signal has not reached the prescribed value within a prescribed reproduction time or within a prescribed number of reproductions,
the light quantity setting unit sets a predetermined reproducing light quantity.

23. The optical disc apparatus of claim 13, wherein the test-reproducing light has a direct current component on which a high frequency component is superimposed, and the reproducing light quantity is set by varying a central value or an amplitude value of the high frequency component.

24. The optical disc apparatus of claim 13, wherein the test-reproducing light has a direct current component on which a high frequency component is superimposed, and the reproducing light quantity is set by selectively varying a central value or an amplitude value of the high frequency component based on manufacturer information of the optical disc.
